(19) United States
(12) Patent Application Publication
(10) Pub. No.: US 2026/0285119 A1
(43) Pub. Date: Sep. 24, 2026

(54) STABILIZER DEVICE

(71) Applicant: CHUO HATSUJO KABUSHIKI KAISHA, Nagoya-shi, Aichi (JP)

(72) Inventor: Toshio KUWAYAMA, Nagoya-shi, Aichi (JP)

(73) Assignee: CHUO HATSUJO KABUSHIKI KAISHA, Nagoya-shi, Aichi (JP)

(21) Appl. No.: 19/135,704

(22) PCT Filed: Mar. 4, 2024
(86) PCT No.: PCT/JP2024/008083

§ 371 Date: Jun. 9, 2026

(30) Foreign Application Priority Data
Mar. 17, 2023 (JP) 2023-043110
Sep. 25, 2023 (JP) 2023-161589

(51) Int. Cl. B60G 21/055; B60G 17/015; B60G 17/019

(52) U.S. Cl. CPC B60G 21/0556; B60G 17/0157; B60G 17/019; B60G 2202/135; B60G 2202/43

(57) ABSTRACT

A stabilizer device is provided. The stabilizer device comprises a first stabilizer and a second stabilizer, an engaging portion, a cam, an elastic member, and an operating portion. The cam is configured for displacing the engaging portion from the non-engaged position to the engaged position. The cam is displaceable between an ON position in which the engaging portion is in the engaged position and an OFF position in which the engaging portion is allowed to be in the non-engaged position. The elastic member is capable of generating a return force, which is an elastic force that displaces the cam from the OFF position to the ON position. The operating portion exerts a force that makes the elastic member elastically deform in a direction that produces the return force.

### CROSS-REFERENCES TO RELATED APPLICATIONS

The present international application claims priorities to Japanese Patent Application No. 2023-043110 filed with the Japan Patent Office on Mar. 17, 2023, and Japanese Patent Application No. 2023-161589 filed with the Japan Patent Office on Sep. 25, 2023, the entire contents of which are incorporated herein by reference.

### TECHNICAL FIELD

The present disclosure relates to a stabilizer device for suppressing roll of a vehicle body.

### BACKGROUND ART

For example, according to the disclosure of Patent Document 1, it is possible to switch between a state in which the first stabilizer and the second stabilizer are connected and a state in which the connection is released.

### PRIOR ART DOCUMENT

### Patent Document

Patent Document 1: Japanese Patent Publication No. 7116155

### SUMMARY

### Problem to Be Solved by the Invention

Patent Document 1 discloses a configuration in which an engaging portion fits into a concave engaged portion provided on the second stabilizer, thereby connecting the first stabilizer and the second stabilizer. Therefore, if the engaging portion is in a position where the engaging portion is deviated with respect to the engaged portion, the first stabilizer and the second stabilizer cannot be connected.

In addition, a user who directly or indirectly operates the stabilizer is usually unable to know about the relative positions of the engaged portion and the engaging portion. Therefore, when the user attempts to connect the first stabilizer and the second stabilizer, if the engaging portion is in a position where the engaging portion is deviated with respect to the engaged portion, the first stabilizer and the second stabilizer cannot be connected.

In view of the above, the present disclosure provides an example of a stabilizer device that enables a user to connect a first stabilizer and a second stabilizer without knowing the relative positions of an engaged portion and an engaging portion.

### Solutions for Solving the Problem

It is desirable for a stabilizer device for suppressing roll of a vehicle body to have, for example, at least one of the following constituent elements.

That is, the constituent elements are: a first stabilizer and a second stabilizer; an engaging portion configured for switching between an ON state in which the first stabilizer and the second stabilizer are connected and an OFF state in which the connection is released, the engaging portion being displaceable between an engaged position in which the engaging portion is engaged with an engaged portion provided on the second stabilizer so as to be in an ON state, and a non-engaged position in which the engaging portion is separated from the engaged portion so as to be in an OFF state; a cam configured for displacing the engaging portion from the non-engaged position to the engaged position, the cam being displaceable between an ON position in which the engaging portion is in the engaged position and an OFF position in which the engaging portion is allowed to be in the non-engaged position; an elastic member capable of generating a return force, which is an elastic force for displacing the cam from the OFF position to the ON position; and an operating portion configured to exert a force that allows the elastic member to be elastically deformed in a direction in such a way that the return force is generated.

Therefore, according to the stabilizer device, if the engaging portion is in a position where the engaging portion is deviated with respect to the engaged portion, the elastic member will still remain in a state where the return force is applied to the engaging portion, i.e., the elastic member still remains in an elastically deformed state.

Moreover, when the second stabilizer is displaced and the engaged portion coincides with the engaging portion, the cam is displaced from the OFF position to the ON position by the elastic force, i.e., the return force, of the elastic member. Therefore, the engaging portion is in the engaged position, and thus the first stabilizer and the second stabilizer are connected to each other in an ON state.

Therefore, the user can connect the first stabilizer and the second stabilizer without knowing the relative positions of the engaged portion and the engaging portion.

### BRIEF DESCRIPTION OF THE DRAWINGS

FIG. 1 is an external view of a stabilizer device according to a first embodiment.

FIG. 2 is a view showing a structure of a stabilizer device according to the first embodiment.

FIG. 3 is an explanatory view illustrating an action of the stabilizer device according to the first embodiment.

FIG. 4 is an explanatory view illustrating an action of the stabilizer device according to the first embodiment.

FIG. 5 is an explanatory view illustrating an action of the stabilizer device according to the first embodiment.

FIG. 6 is an explanatory view illustrating an action of the stabilizer device according to the first embodiment.

FIG. 7 is an enlarged view of a locking hook and a protrusion, etc., according to the first embodiment.

FIG. 8 is a view showing a cam ring according to the first embodiment.

FIG. 9 is a view showing a transmission mechanism according to the first embodiment.

FIG. 10 is a view showing a transmission mechanism according to the first embodiment.

FIG. 11 is a block diagram of a control system of the electric motor according to the first embodiment.

### DESCRIPTION OF REFERENCE SIGNS

1 stabilizer device, 3 first stabilizer, 3A first torsion portion, 5 second stabilizer, 5A second torsion portion, 10 coupling device, 11 housing, 13 engaging device, 13A locking hook (engaging portion), 13B cam ring, 13C return spring, 13E ring portion, 13F protrusion, 15 driving device, 15A driving spring, 15B electric motor, 15C transmission mechanism, 15D output portion, 15E worm, 15F worm wheel, 15G first sector gear, 15H second sector gear, 15J gear portion, 16 shaft member, 16A recess (engaged portion).

### DETAILED DESCRIPTION OF THE EMBODIMENTS

The following “embodiment” shows an example of an embodiment falling within the technical scope of the present disclosure. That is, the present disclosure is not limited to the specific constitutions or configurations shown in the following embodiments.

In addition, arrows indicating directions and diagonal lines are indicated in the drawings to make it easier to understand the relationships between the figures and the shapes of members or parts. Therefore, the present disclosure is not limited to the directions indicated in the drawings. The drawings marked with oblique lines do not necessarily show cross-sectional views.

Regarding one member or part described to which a reference sign is given, unless specifically limited to “one” or equivalent, there is at least one such member or part. In other words, when “one” or similar limitations are not specified, two or more members may be present. The stabilizer device disclosed herein has at least the constituent elements, such as the members or parts denoted by reference signs and described, and at least one of the structural parts depicted in the figures.

### First Embodiment

### 1. Overview of the Stabilizer Device

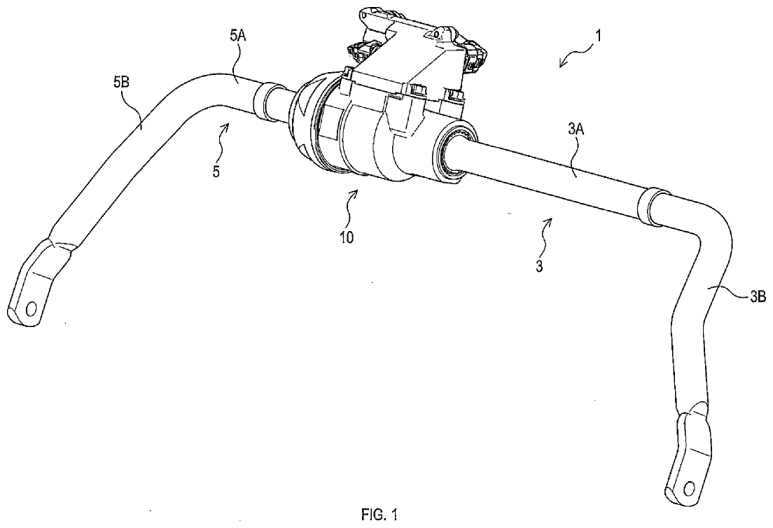

The stabilizer device is a device that suppresses roll of a vehicle body (not shown). FIG. 1 shows a stabilizer device 1 according to the present embodiment. The stabilizer device 1 comprises a first stabilizer 3, a second stabilizer 5, a coupling device 10, and the like.

The first stabilizer 3 is made of a single steel material having a first torsion portion 3A and an arm portion 3B. The second stabilizer 5 is made of a single steel material having a second torsion portion 5A and an arm portion 5B.

The first torsion portion 3A and the second torsion portion 5A are round bar-shaped parts that mainly undergo torsional deformation. The arm portion 3B extends in a direction intersecting with the lengthwise direction of the first torsion portion 3A. Furthermore, the front end side of the arm portion 3B in the extending direction is rotatably connected to the vehicle body.

The arm portion 5B extends in a direction intersecting with the lengthwise direction of the second torsion portion 5A. Furthermore, the front end side of the arm portion 5B in the extending direction is rotatably connected to the vehicle body. In addition, in a state where the arm portions 3B and 5B are connected to the vehicle body, the lengthwise directions of the first torsion portion 3A and the second torsion portion 5A substantially coincide with the width direction of the vehicle.

### 2. Coupling Device

### 2.1 Overview of the Coupling Device

The coupling device 10 is a switching device configured for switching the connection state between the first torsion portion 3A and the second torsion portion 5A into an ON state or an OFF state.

In the ON state, the rotation force input to the first torsion portion 3A can be transmitted to the second torsion portion 5A. In addition, the rotation force input to the second torsion portion 5A can be transmitted to the first torsion portion 3A. In the OFF state, the transmission of the rotation force is cut off.

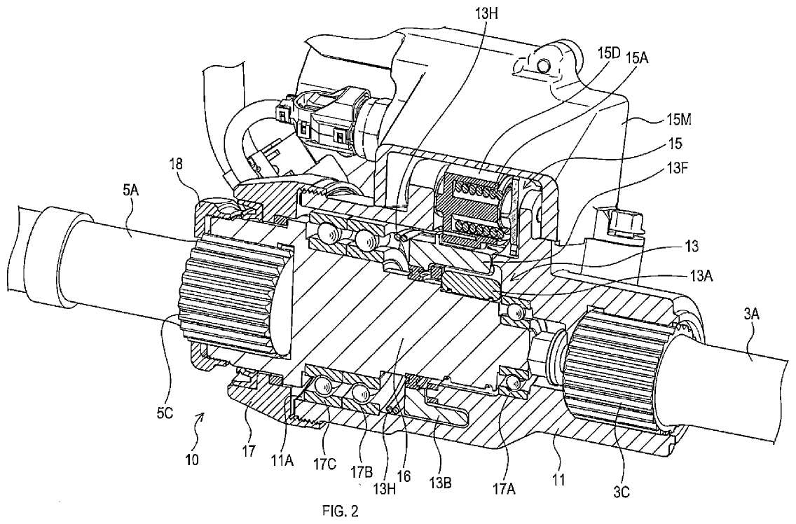

As shown in FIG. 2, the coupling device 10 comprises a housing 11, an engaging device 13, a driving device 15 and the like. One of the first torsion portion 3A and the second torsion portion 5A is fixed by the housing 11, and the other one of the first torsion portion 3A and the second torsion portion 5A is rotatably supported by the housing 11.

The first torsion portion 3A is fixed to the housing 11 of the present embodiment via the spline 3C, and the second torsion portion 5A is supported to be rotatable by the housing 11 via the shaft member 16. The shaft member 16 is supported to be rotatable in the cylindrical portion 11A of the housing 11 via bearings 17A to 17C.

In addition, the shaft member 16 is a locking rod made of a material, such as chrome-molybdenum steel, having a higher hardness than those of the first torsion portion 3A and the second torsion portion 5A. The cylindrical portion 11A has an opening closed by a cover 17.

Moreover, the second torsion portion 5A is fixed to the shaft member 16 via the spline 5C. Therefore, the second torsion portion 5A is supported to be rotatable relative to the housing 11.

In the present embodiment, the shaft member 16 is integrated with the second torsion portion 5A. Therefore, in the following description, the the second torsion portion 5A refers to as a part including a shaft member 16. In addition, the second torsion portion 5A is restricted from falling off from the shaft member 16 by the cap 18.

The engaging device 13 is switchable between a state in which the second torsion portion 5A is rotatable relative to the housing 11 and a state in which the second torsion portion 5A is not rotatable relative to the housing 11. The driving device 15 is an example of an electric actuator for switching the states of the engaging device 13.

### 2.2 Details of the Engaging Device

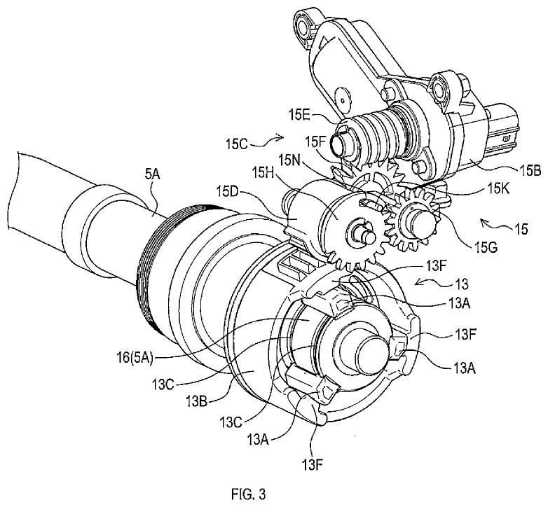

As shown in FIG. 3, the engaging device 13 comprises a locking hook 13A, a cam ring 13B, a return spring 13C, and the like. The locking hook 13A is an example of an engaging portion for switching between the ON state and the OFF state.

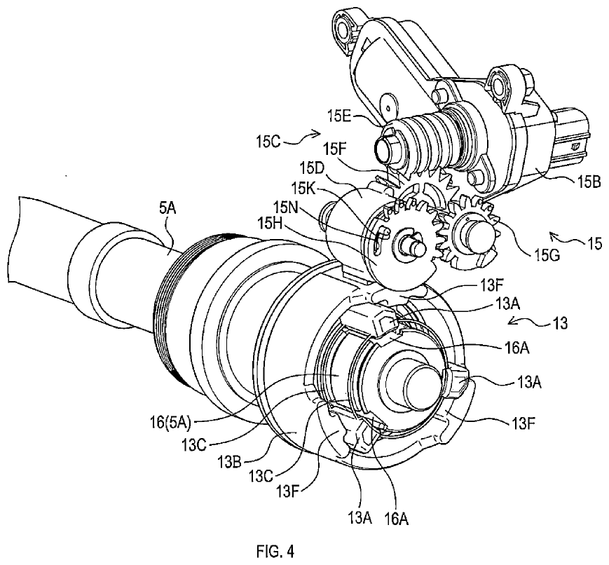

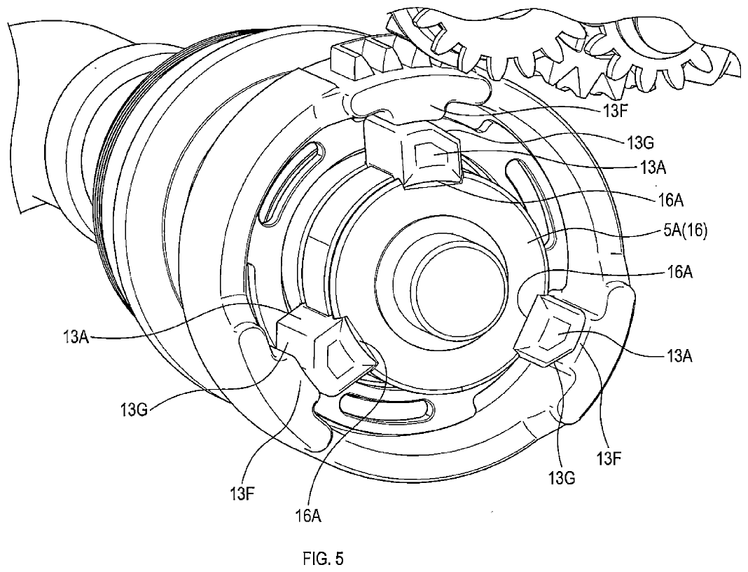

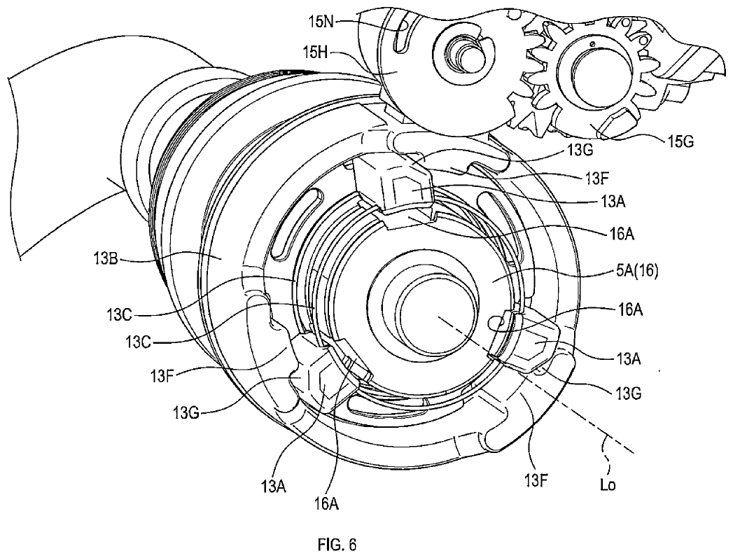

Specifically, the locking hook 13A is displaceable between an engaged position (see FIG. 5) where the locking hook is engaged with an engaged portion 16A (see FIG. 4) provided in the second torsion portion 5A (the shaft member 16 in the present embodiment) and a non-engaged position (see FIG. 6) where the locking hook is separated from the engaged portion 16A.

Therefore, if the locking hook 13A is in the engaged position, the coupling device 10 is in the ON state. If the locking hook 13A is in the non-engaged position, the coupling device 10 is in the OFF state.

A plurality of locking hooks 13A are provided (there are three locking hooks in the present embodiment). The number of the engaged portions 16A provided is the same as the number of the locking hooks 13A. As shown in FIG. 6, the locking hooks 13A and the engaged portions 16A are provided at equal intervals on a circumference centered on the central axis Lo of the second torsion portion 5A.

In addition, the plurality of locking hooks 13A are engaged with a portion of the housing 11. Therefore, the plurality of locking hooks 13A are rotated integrally with the housing 11, that is, with the first torsion portion 3A.

The return spring 13C is an example of a second elastic member that generates an elastic force, that is, a displacement force, for displacing each locking hook 13A toward the non-engaged position. Therefore, if each locking hook 13A is in a state where it can be displaced toward the non-engaged position, each locking hook 13A is displaced to the non-engaged position by the displacement force of the return spring 13C.

The return spring 13C of the present embodiment is a substantially C-shaped spring in which a cut portion is provided in a part of an annular spring steel material. In addition, in the present embodiment, the return spring 13C is composed of a plurality of C-shaped springs.

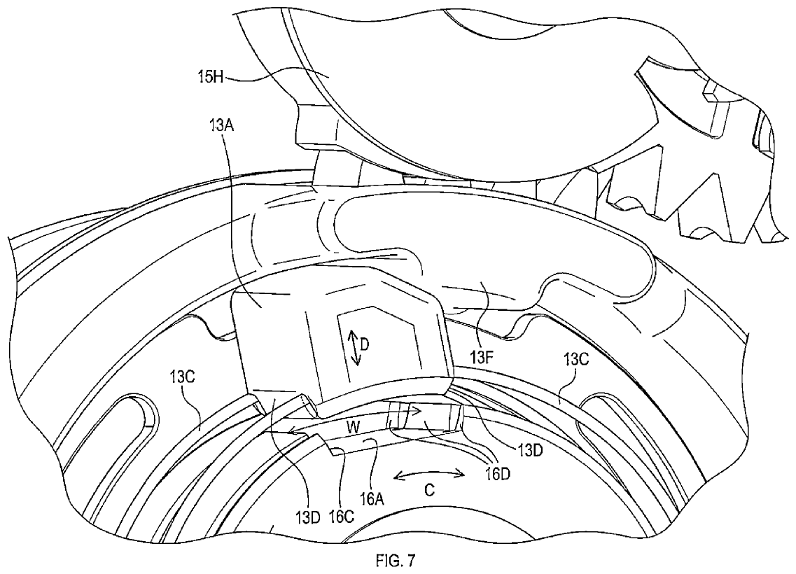

As shown in FIG. 7, each engaged portion 16A is formed by a concave groove that is recessed toward the central axis Lo. Tapered inclined surfaces 16C and 16D are provided on first and second end surfaces, intersecting the circumferential direction C, of each of the plurality of engaged portions 16A (hereinafter referred to as the recess 16A). The inclined surface 16C (first end surface) and the inclined surface 16D (second end surface) are arranged to face each other across the recess 16A.

Each of the inclined surfaces 16C and 16D is a surface inclined with respect to a displacement direction D of the locking hook 13A in such a way that the groove width W decreases as the inclined surface approaches the central axis Lo. In addition, the circumferential direction C is a direction that coincides with the rotation direction of the second torsion portion 5A.

The displacement direction D of the locking hook 13A is a direction that coincides with the radial direction of the second torsion portion 5A. The groove width W is a dimension measured in a direction parallel to the circumferential direction in an imaginary plane. The imaginary plane is projected to be orthogonal to the displacement direction D of the locking hook 13A.

Moreover, an inclined portion 13D substantially parallel to the inclined surfaces 16C and 16D is provided at a part of each locking hook 13A that faces the inclined surfaces 16C and 16D. The inclined surfaces 16C and 16D and the inclined portion 13D are structures for reliably displacing the locking hook 13A to the non-engaged position.

That is, when each locking hook 13A is in a state of being in the engaged position (see FIG. 5), if a rotation force is applied to the second torsion portion 5A, a force is exerted on each locking hook 13A, enabling the locking hook to displace from the inclined surfaces 16C and 16D to the non-engaging position.

The cam ring 13B is an example of a cam for displacing each locking hook 13A from the non-engaged position to the engaged position, and is displaceable between an ON position (see FIG. 5) in which the locking hook 13A is in the engaged position and an OFF position (see FIG. 6) in which the locking hook 13A is allowed to be in the non-engaged position.

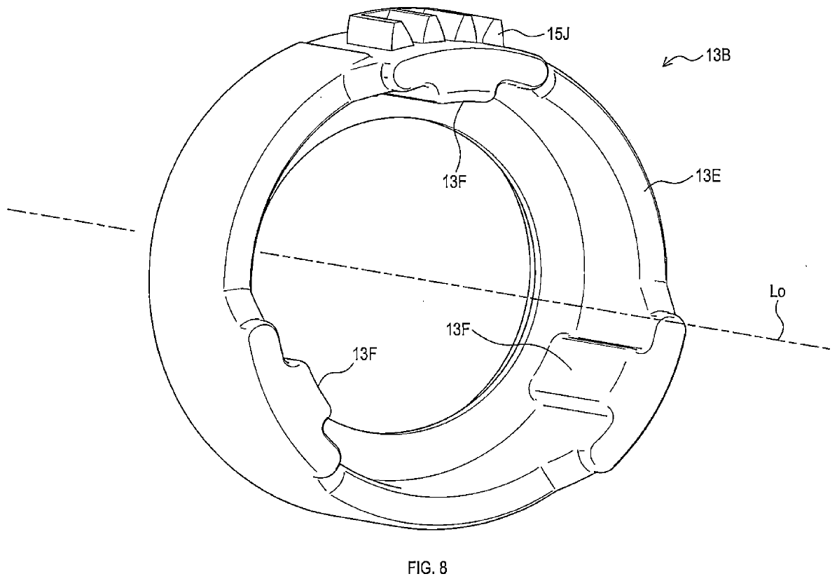

Specifically, as shown in FIG. 8, the cam ring 13B comprises a ring portion 13E, a protrusion 13F, and the like. In addition, the ring portion 13E and the protrusion 13F are integrated by integral molding.

The ring portion 13E is an annular part that is rotatable about the central axis Lo. The protrusion 13F is a protrusion that protrudes from the inner peripheral surface of the ring portion 13E toward the second stabilizer 5 side, that is, toward the recess 16A. In addition, the number of the protrusions 13F provided is the same as that of the locking hooks 13A.

Moreover, when the ring portion 13E is rotationally displaced from the OFF position (see FIG. 6) toward the ON position side (see FIG. 5) (hereinafter referred to as ON displacement), each protrusion 13F slides to be in contact with the corresponding locking hook 13A, placing the locking hook 13A in the engaged position. Hereinafter, the rotation displacement in the direction opposite to the ON displacement is referred to as the OFF displacement.

Therefore, at least one of each locking hook 13A and each protrusion 13F is provided with an inclined surface 13G (see FIG. 5) that converts the rotation force, by which the cam ring 13B performs the ON displacement, into a force by which the locking hook 13A is displaced. In addition, the inclined surface 13G of the present embodiment is provided in each locking hook 13A.

Moreover, the cam ring 13B is constantly subjected to an elastic force from a restoring spring 13H (see FIG. 2). The restoring spring 13H generates an elastic force, i.e., a restoring force, which displaces the cam ring 13B from the ON position (see FIG. 5) to the OFF position (see FIG. 6).

### 2.3 Details of the Driving Device

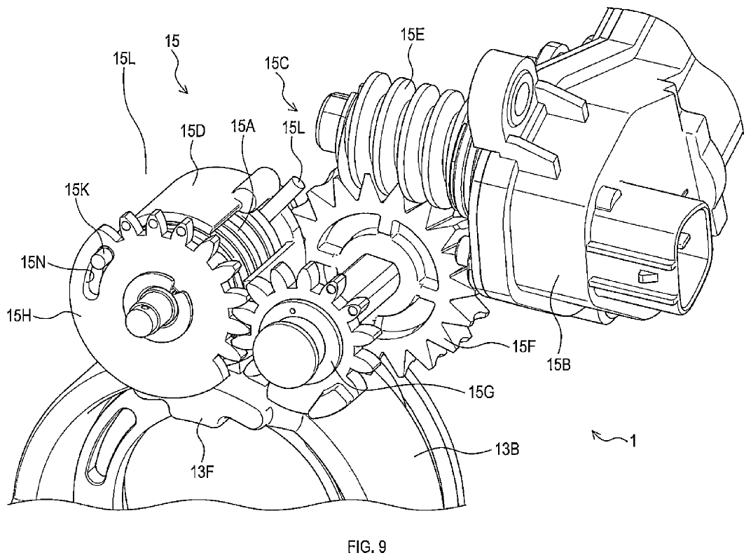

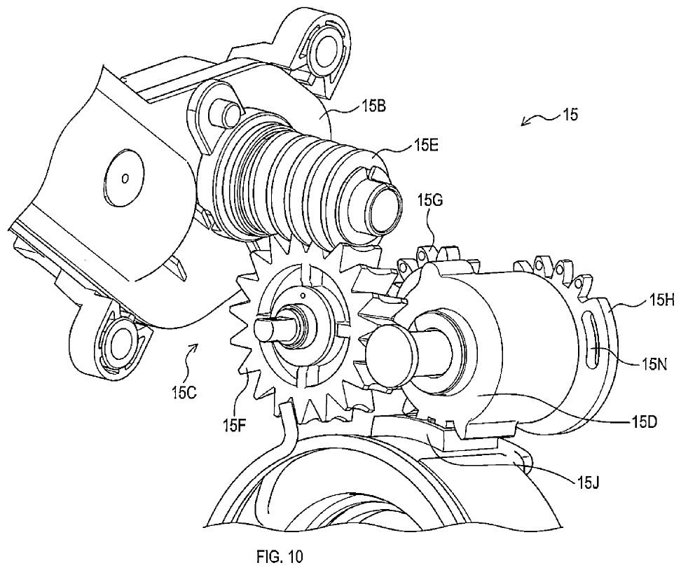

As shown in FIG. 9, the driving device 15 comprises a driving spring 15A, an electric motor 15B, a transmission mechanism 15C, an output portion 15D (see FIG. 10), and the like. In addition, the driving device 15 is covered with a cover 15M (see FIG. 2).

The driving spring 15A is an example of an elastic member that can generate an elastic force, i.e., a return force. The elastic force is applied to displace the ring portion 13E from the OFF position to the ON position. The driving spring 15A of the present embodiment is a torsion coil spring that generates a return force when torsionally deformed.

The electric motor 15B is an example of an operating portion that generates a force for elastically deforming the driving spring 15A to displace the ring portion 13E from the OFF position to the ON position. In addition, the electric motor 15B of the present embodiment is a gear motor integrated with a speed reducer.

The transmission mechanism 15C is a mechanism that decelerates the rotation output of the electric motor 15B and transmits the decelerated rotation output to the driving spring 15A so that the driving spring 15A is torsionally deformed. Specifically, the transmission mechanism 15C comprises a worm 15E, a worm wheel 15F, a first sector gear 15G, a second sector gear 15H, and the like.

The worm 15E is rotated if the worm is subjected to a driving force from an output shaft (not shown) of the electric motor 15B. The worm wheel 15F is a gear engaged with the worm 15E. The first sector gear 15G and the second sector gear 15H are configured to transmit the output of the worm wheel 15F to the driving spring 15A.

As shown in FIG. 9, the driving spring 15A has a first end portion 15K that is locked to the second sector gear 15H. The second sector gear 15H is provided with a locking hole 15N to which the first end portion 15K of the driving spring 15A is locked.

The locking hole 15N is configured as an arc-shaped elongated hole extending in the rotation direction of the second sector gear 15H. The second end portion 15L of the driving spring 15A is locked to the output portion 15D. Furthermore, the output portion 15D is engaged with a gear portion 15J (see FIG. 10) provided on the ring portion 13E. In addition, the second end portion 15L of the driving spring 15A is an end portion of the driving spring 15A that is on the opposite side to the first end portion 15K.

Furthermore, the restoring force applied to the cam ring 13B by the restoring spring 13H when the cam ring 13B is in the ON position is greater than the return force applied to the cam ring 13B by the driving spring 15A when the cam ring 13B is in the ON position.

In addition, in the present embodiment, when the cam ring 13B is in the ON position, the return force applied by the driving spring 15A to the cam ring 13B is substantially 0. That is, when the cam ring 13B is in the ON position, the driving spring 15A is substantially not elastically deformed. On the other hand, when the cam ring 13B is in the ON position, the restoring spring 13H is elastically deformed.

Hereinafter, the rotation of the output portion 15D, conducted to allow the cam ring 13B to perform the ON displacement, is referred to as the ON rotation. The rotation of the output portion 15D, conducted to allow the cam ring 13B to perform the OFF displacement, is referred to as the OFF rotation.

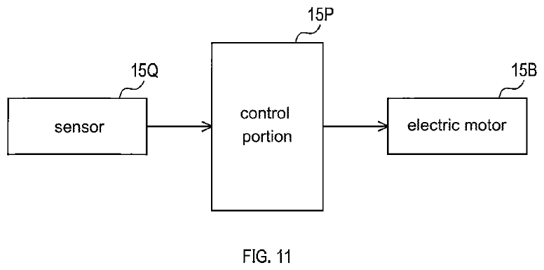

Moreover, the electric motor 15B can perform either an ON rotation in a direction in such a way that a return force is generated, or an OFF rotation in a direction opposite to the ON rotation. As shown in FIG. 11, an action of the electric motor 15B is controlled by a control portion 15P.

A detection signal from the sensor 15Q is input to the control portion 15P. Then, the control portion 15P controls the stopping and driving of the electric motor 15B by using the detection signal of the sensor 15Q. The sensor 15Q detects whether the deformation amount of the driving spring 15A has reached a predetermined deformation amount.

Specifically, in the event that the electric motor 15B performs the ON rotation, if the sensor 15Q detects that the deformation amount of the driving spring 15A has reached a predetermined deformation amount, the control portion 15P is configured to stop the action of the electric motor 15B.

In addition, the sensor 15Q of the present embodiment comprises a position-limiting switch, a proximity switch, or the like. The control portion 15P is a control circuit composed of a control circuit using a microcomputer or a dedicated electric circuit (hardware).

### 3. Action and Features of the Stabilizer Device of the Present Embodiment

When each locking hook 13A is in the non-engaged position (see FIG. 6), if the output portion 15D performs the ON rotation, the driving spring 15A is torsionally deformed, thereby generating a return force. Therefore, the cam ring 13B is displaced from the OFF position (see FIG. 6) to the ON position (see FIG. 5) by the return force.

In this case, on the assumption that the locking hooks 13A are in positions where the locking hooks are deviated with respect to the recesses 16A, the driving spring 15A is still in a state where the return force is acting on the locking hooks 13A, that is, the driving spring is still in an elastically deformed state.

Then, when the second torsion portion 5A is rotationally displaced and the recesses 16A coincide with the locking hooks 13A, the ring portion 13E is displaced from the OFF position to the ON position by the return force. As a result, the locking hooks 13A are in the engaged position (see FIG. 5).

Therefore, the first torsion portion 3A and the second torsion portion 5A connected to each other are in an ON state (see FIG. 5). Therefore, the user can couple the first torsion portion 3A and the second torsion portion 5A without knowing the relative positions of the recess 16A and the locking hook 13A.

Furthermore, when each locking hook 13A is in the engaged position (see FIG. 5), if the output portion 15D performs the OFF rotation, the return force of the driving spring 15A disappears. Therefore, the cam ring 13B is displaced from the ON position (see FIG. 5) to the OFF position (see FIG. 6) by the restoring force of the restoring spring 13H (see FIG. 2).

Therefore, each locking hook 13A is displaced from the engaged position to the non-engaged position by the displacement force of the return spring 13C. In addition, even if the rotation force is still applied on the second torsion portion 5A, due to the rotation force, a force is applied on each locking hook 13A to displace the locking hook 13A from the inclined surfaces 16C and 16D to the non-engaged position. Therefore, each locking hook 13A is reliably displaced from the engaged position to the non-engaged position.

The transmission mechanism 15C comprises a worm 15E and a worm wheel 15F. Thus, even if a force for rotating the cam ring 13B is input from the second torsion portion 5A, the electric motor 15B acting as the operating portion can be suppressed from rotating.

This is because the rotation force is easily transmitted from the worm 15E to the worm wheel 15F, but it is difficult to transmit the rotation force from the worm wheel 15F to the worm 15E.

The second sector gear 15H is provided with a locking hole 15N to which the first end portion 15K of the driving spring 15A is locked. The locking hole 15N is configured as an arc-shaped elongated hole extending in the rotation direction of the second sector gear 15H. Thus, when the cam ring 13B is in the ON position, the return force applied to the cam ring 13B by the driving spring 15A can be reliably set to be approximately zero.

That is, if the locking hole 15N is a simple round hole, due to dimensional deviations of the driving spring 15A and the like, the driving spring 15A may be in an elastically deformed state when the cam ring 13B is in the ON position.

Moreover, under the assumption that the driving spring 15A is elastically deformed when the cam ring 13B is in the ON position, there is a possibility that the restoring force applied to the cam ring 13B by the restoring spring 13H when the cam ring 13B is in the ON position is equal to or less than the return force applied to the cam ring 13B by the driving spring 15A when the cam ring 13B is in the ON position (hereinafter referred to as the reverse state of the elastic force).

If the reverse state of the elastic force occurs, it becomes impossible to hold the cam ring 13B in the ON position. Accordingly, each locking hook 13A is displaced from the engaged position to the non-engaged position, and the stabilizer device 1 is brought into the OFF state.

In contrast, according to the stabilizer device 1 of the present embodiment, when the cam ring 13B is in the ON position, the return force applied to the cam ring 13B by the driving spring 15A can be reliably made substantially zero, so that the cam ring 13B can be reliably held in the ON position.

### Other Embodiments

In the above embodiment, the electric motor 15B is used as the operating portion. However, the present disclosure is not limited thereto. That is, in this disclosure, for example, the operation portion may be an operation portion that rotates the output portion 15D by manually operating an operation cable.

The transmission mechanism 15C of the above embodiment comprises the worm 15E and the worm wheel 15F. However, the present disclosure is not limited thereto. That is, in this disclosure, for example, a transmission mechanism composed of a plurality of spur gears may be used.

In the above embodiment, the torsion coil spring is used as the elastic member capable of generating the return force. However, the present disclosure is not limited thereto. That is, in this disclosure, for example, a general coil spring may be used.

In the above embodiment, the inclined surfaces 16C, 16D, and 13D are provided. However, the present disclosure is not limited thereto. That is, in this disclosure, for example, there is provided a configuration in which at least one of the inclined surfaces 16C, 16D, and 13D is eliminated.

In the above embodiment, the recess 16A is provided in the shaft member 16. However, the present disclosure is not limited thereto. That is, in this disclosure, for example, the shaft member 16 may be eliminated and the recess 16A may be provided in the second torsion portion 5A.

In the above embodiment, the transmission mechanism 15C is provided. However, the present disclosure is not limited thereto. That is, in this disclosure, for example, there is also provided a structure in which the transmission mechanism 15C may be eliminated and the driving spring 15A may be directly operated.

The control portion 15P in the above embodiment controls the stopping of the electric motor 15B by using the detection signal of the sensor 15Q. However, the present disclosure is not limited thereto. That is, in this disclosure, for example, the sensor 15Q may be eliminated and a stopper may be provided to limit the deformation amount of the driving spring 15A or restrict the rotation angle of the second sector gear 15H from exceeding a predetermined amount.

Moreover, there may also provided a control that, when the rotation of the electric motor 15B is forcibly stopped by the stopper and the drive current of the electric motor 15B exceeds a specified value, the electric motor 15B may be stopped.

Moreover, the present disclosure only needs to conform to the spirit of the disclosure described in the above-mentioned embodiments, and is not limited to the above-mentioned embodiments. Therefore, it may be a configuration in which at least two of the above-described embodiments are combined, or a configuration in which any of the illustrated constituent elements or the constituent elements described with reference signs in the above-described embodiments are eliminated.

1. A stabilizer device for suppressing roll of a vehicle body, comprising:
a first stabilizer and a second stabilizer;
an engaging portion configured for switching between an ON state in which the first stabilizer and the second stabilizer are connected and an OFF state in which the connection is released, the engaging portion being displaceable between an engaged position in which the engaging portion is engaged with an engaged portion provided on the second stabilizer so as to be in an ON state, and a non-engaged position in which the engaging portion is separated from the engaged portion so as to be in an OFF state;
a cam configured for displacing the engaging portion from the non-engaged position to the engaged position, the cam being displaceable between an ON position where the engaging portion is in the engaged position and an OFF position where the engaging portion is allowed to be in the non-engaged position;
an elastic member capable of generating a return force, which is an elastic force for displacing the cam from the OFF position to the ON position; and
an operating portion configured to exert a force that allows the elastic member to be elastically deformed in a direction in such a way that the return force is generated.

2. The stabilizer device according to claim 1, wherein the cam comprises:
an annular ring portion being rotatable about a shaft central axis of the second stabilizer; and
a protrusion protruding from an inner peripheral surface of the ring portion towards the second stabilizer, wherein when the ring portion is displaced in a rotational manner from an OFF position towards an ON position, the protrusion slides while being in contact with the engaging portion and allows the engaging portion to be in an engaged position, and
wherein the elastic member is a torsion coil spring that generates a return force when torsionally deformed.

3. The stabilizer device according to claim 2, wherein:
the operating portion is an electric motor;
the stabilizer device comprises a transmission mechanism that decelerates a rotation output of the electric motor and transmits the decelerated rotation output to the torsion coil spring, thereby torsionally deforming the torsion coil spring; and
the transmission mechanism comprises a worm and a worm wheel engaged with the worm.

4. The stabilizer device according to claim 3, wherein:
the stabilizer device comprises a second elastic member which generates a displacement force that is an elastic force for displacing the engaging portion toward a non-engaged position;
the electric motor is rotatable in a direction in such a way that a return force is generated as well as in a direction opposite to said direction.

5. The stabilizer device according to claim 4, wherein the stabilizer device comprises:
a sensor configured for detecting whether a deformation amount of the torsion coil spring has reached a predetermined deformation amount; and
a control portion configured to control the operation and stopping of the electric motor, wherein the control portion is configured to stop the electric motor from operating when the sensor detects that the deformation amount of the torsion coil spring has reached a predetermined deformation amount.

6. The stabilizer device according to claim 5, wherein:
the stabilizer device comprises a restoring spring which applies a restoring force on the cam, and the restoring force is an elastic force that displaces the cam from an ON position to an OFF position; and
the restoring force applied by the restoring spring to the cam when the cam is in the ON position is greater than the return force applied by the torsion coil spring to the cam when the cam is in the ON position.

7. The stabilizer device according to claim 6, wherein:
the stabilizer device comprises a gear to which a first end of the torsion coil spring is locked, and the gear is configured for transmitting an output of the worm wheel to the torsion coil spring;
the gear is provided with a locking hole to which the first end of the torsion coil spring is locked; and
the locking hole is formed by an elongated hole extending in a rotation direction of the gear.

8. The stabilizer device according to claim 1, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

9. The stabilizer device according to claim 2, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

10. The stabilizer device according to claim 3, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

11. The stabilizer device according to claim 4, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

12. The stabilizer device according to claim 5, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

13. The stabilizer device according to claim 6, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.

14. The stabilizer device according to claim 7, wherein:
the engaged portion is formed by a concave groove that is recessed toward a central axis of the second stabilizer; and
tapered inclined surfaces are provided on first and second end surfaces arranged in the circumferential direction of the engaged portion, and the inclined surfaces are surfaces inclined with respect to a displacement direction of the engaging portion in such a way that a groove width decreases as such inclined surface approaches the central axis.
